(19) United States
(12) Patent Application Publication
(10) Pub. No.: US 2005/0053763 A1
(43) Pub. Date: Mar. 10, 2005

(54) Cushion fabric

(76) Inventor: Jack Lee, Taichung City (TW)

Correspondence Address: CHARLES E. BAXLEY, ESQUIRE, Third Floor, 90 John Street, New York, NY, 10038, US

(21) Appl. No.: 10/658,144

(22) Filed: Sep. 8, 2003

(51) Int. Cl. B32B 3/10

(52) U.S. Cl. 428/131

(57) ABSTRACT

A cushion fabric generally includes a first breathable layer, a filter layer and a second breathable layer, which are integrally combined together by hot pressing approach. Wherein the first and second breathable layers are made of non-woven fabrics, the filter layer contains active carbon, thereby this cushion fabric can be applied to producing variety of commodities, such as sofa cushion, inner sole, anti-skidding mat, carpet, gauze mask and the likes, such that the commodities will not only have good breathing ability but also can isolate the organic poison from outside and eliminate the unpleasing odor of the air.

### BACKGROUND OF THE INVENTION

1. Field of the Invention

The present invention relates to a cushion fabric, and more particularly to a cushion fabric which can be applied to making the OK bond, sofa cushion, inner sole, anti-skidding mat, sanitary protecting pad, carpet, gauze mask and the likes.

2. Description of the Prior Arts

There are varieties of breathable commodities, such as OK bond, sanitary protecting pad, inner sole, anti-skidding mat and the likes, all of which need to touch the user's body, thereby good breathability will be the user's first consideration. However, due to the structures of the breathable commodities are much varied, besides breathability, the commodities will be more competitive if further having the functions of isolating the organic poison as well as eliminating the unpleasing odor of the air, and this also has become the motivation of the present invention.

The present invention has arisen to mitigate and/or obviate the afore-described disadvantages of the conventional breathable cushion fabric.

### SUMMARY OF THE INVENTION

The primary object of the present invention is to provide a cushion fabric, wherein between two non-woven-fabric-made breathable layer of which are provided with a filter layer containing active carbon, the cushion fabric of this kind can be applied to producing OK bond, sanitary protecting pad, carpet, gauze mask and the likes.

Another object of the present invention is to provide a cushion fabric, wherein on a surface of the breathable layer is attached with an adhesion layer, the cushion fabric of this kind can be applied to producing inner soles, anti-skidding mat and the likes.

The present invention will become more obvious from the following description when taken in connection with the accompanying drawings, which shows, for purpose of illustrations only, the preferred embodiments in accordance with the present invention.

### BRIEF DESCRIPTION OF THE DRAWINGS

FIG. 1 is an exploded view of a cushion fabric in accordance with a first embodiment of the present invention;

FIG. 2 is a cross-sectional view of the cushion fabric in accordance with a first embodiment of the present invention;

FIG. 3 is a perspective view of an OK bond made of the cushion fabric in accordance with a first embodiment of the present invention;

FIG. 4 is a perspective view of a gauze mask made of the cushion fabric in accordance with a first embodiment of the present invention;

FIG. 5 is an exploded view of an inner sole made of the cushion fabric in accordance with a second embodiment of the present invention;

FIG. 6 is a cross-sectional of the inner sole of FIG. 5.

### DETAILED DESCRIPTION OF THE PREFERRED EMBODIMENTS

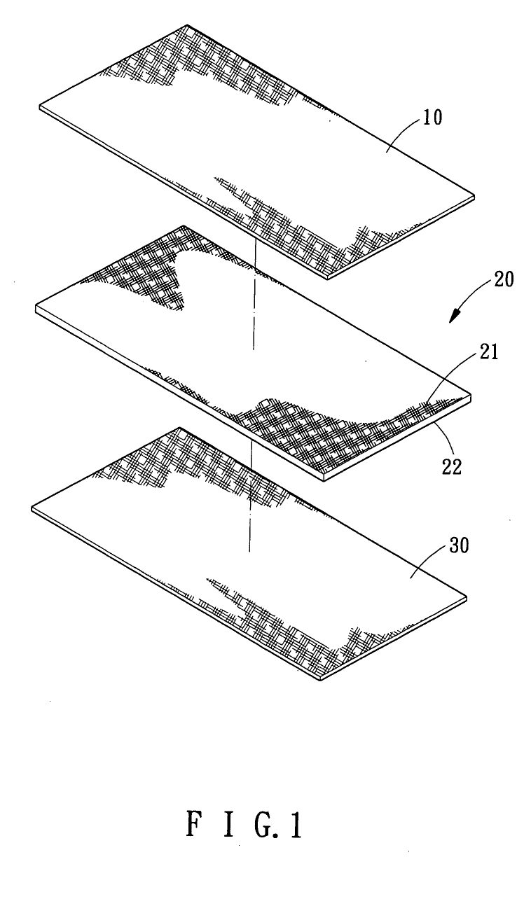

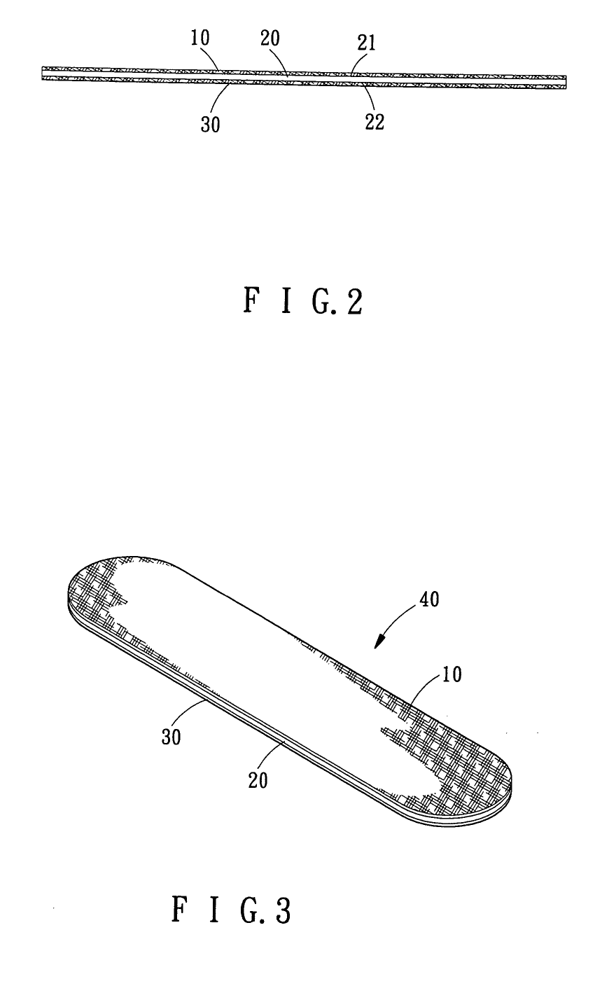

Referring to FIGS. 1-2, which shows a cushion fabric in accordance with a first embodiment of the present invention, wherein the cushion fabric generally comprises a first breathable layer 10, a filter layer 20 and a second breathable layer 30.

The first breathable layer 10 is made of non-woven fabrics and serves to allow the passage of the user's body heat.

The filter layer 20 is also made of non-woven fabrics containing active carbon, which has a first surface 21 and a second surface 22, the first surface 21 is pressed against and integrally combined with the first breathable layer 10 by hot pressing approach, since the filer layer 20 contains active carbon, which not only can isolate the organic poison from outside but also eliminate the unpleasing odor or the air.

The second breathable layer 30 is made of non-woven fabrics and serves to allow the passage of the user's body heat. The surface of the second breathable layer 30 is pressed against and integrally combined with the second surface 22 of the filter layer 20 by hot pressing approach.

Referring to FIG. 3, wherein an OK bond 40 is made of the above-mentioned cushion fabric and applied to dress a wound of the user. Since the first and the second breathable layer 10, 30 are made of non-woven fabrics, which allow the passage of the user's body heat so as to make the wound breathable. Furthermore, due to the characteristics of the filter layer 20, which is employed to isolate the organic poison from outside, such that prevent a secondary hurt to the wound.

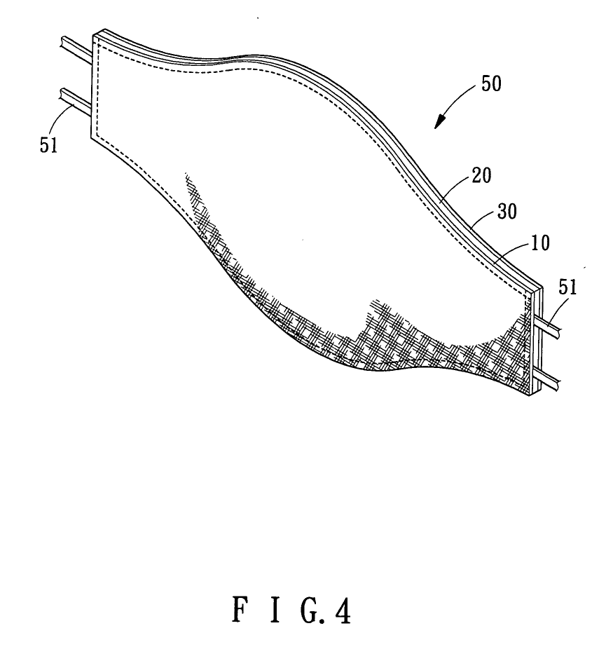

Referring to FIG. 4, wherein a gauze mask 50 is also made of the cushion fabric of the present invention. At both sides of the gauze mask 50 is provided with a suspension loop 51 respectively for user's wearing. In like manner, the first and the second breathable layer 10, 30 allow the passage of the user's body heat and the filter layer 20 is employed to isolate the organic poison outside of the user's body. In addition, the cushion fabric of the present invention also can be used to make sanitary protecting pad for a patient lying on, so as to keep the body of the patient breathable.

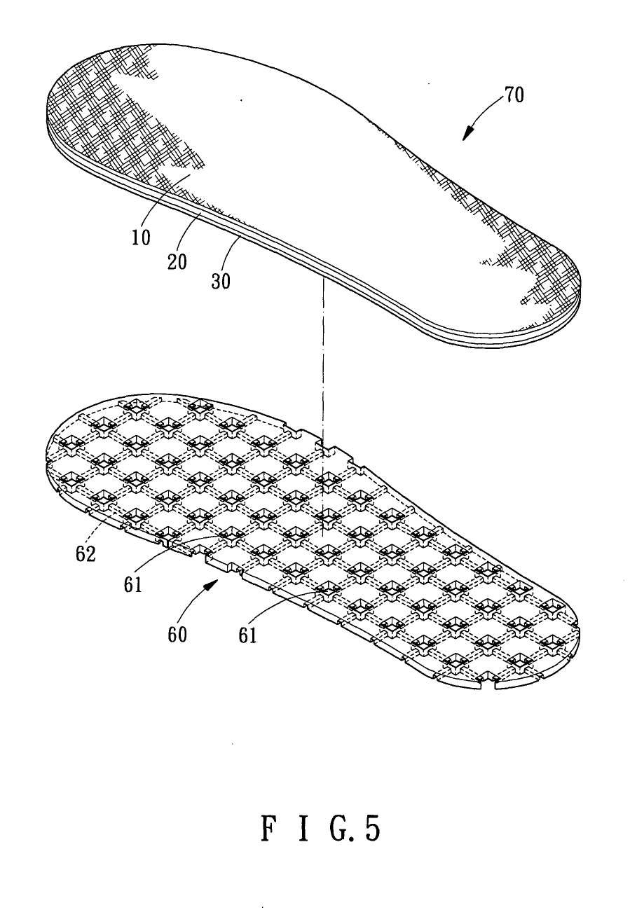

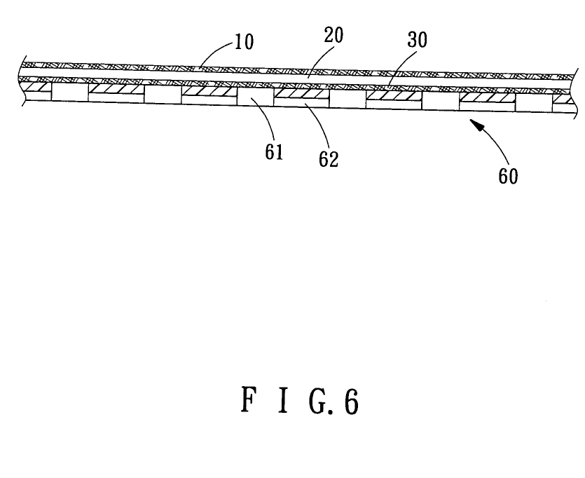

Referring further to FIGS. 5 and 6, which shows a cushion fabric in accordance with a second embodiment of the present invention. Since the fabric structure of the cushion fabric of the second embodiment is similar with that of the first embodiment of the present invention, further remarks on this matter would seem superfluous. The distinct of the second embodiment from the first embodiment is that: on a surface of the second breathable layer 30 (or the first breathable layer 10) of the cushion fabric in accordance with the second embodiment of the present invention is attached with an adhesion layer 60. Wherein the adhesion layer 60 is made of foaming material EVA and on which a plurality of gas holes 61 are evenly distributed, each paired neighboring gas holes 61 are connected by a groove 62. Such that the adhesion layer 60 can be combined with the cushion fabric so as to form an inner sole 70. And thus the inner sole 70 has the first and the second breathable layer 10, 30 for allowing passage of the user's body heat as well as the filter layer 20 having deodorizing function, besides, it further has the adhesion layer 60 provided with gas holes 61 as well as grooves 62 which are capable of improving the air permeability of the inner sole. In addition, this cushion fabric also can be applied to producing variety of commodities, such as sofa cushion, anti-skidding mat, carpet and the likes.

While we have shown and described various embodiments in accordance with the present invention, it should be clear to those skilled in the art that further embodiments may be made without departing from the scope of the present invention.

1. A cushion fabric generally comprising a first breathable layer, a filter layer and a second breathable layer, the three layers being integrally combined together to form the cushion fabric by hot pressing approach, wherein the first breathable layer being pressed against a first surface of the filter layer, a second surface of the filter layer being pressed against and combined with the second breathable layer, the first breathable layer and the second breathable layer being made of non-woven fabrics, the filter layer containing active carbon.

2. The cushion fabric as claimed in claim 1, further comprising an adhesion layer attached to the first breathable layer.

3. The cushion fabric as claimed in claim 1, further comprising an adhesion layer attached to the second breathable layer.

4. The cushion fabric as claimed in claim 2, wherein the adhesion layer is defined with plural gas holes, each paired neighboring gas holes are connected by a groove respectively.

5. The cushion fabric as claimed in claim 3, wherein the adhesion layer is defined with plural gas holes, each paired neighboring gas holes are connected by a groove respectively.

6. The cushion fabric as claimed in claim 2, wherein the adhesion layer is made of foaming material EVA.

7. The cushion fabric as claimed in claim 3, wherein the adhesion layer is made of foaming material EVA.
